(19) United States
(12) Patent Application Publication
(10) Pub. No.: US 2005/0197848 A1
(43) Pub. Date: Sep. 8, 2005

(54) Airport customer support dispatch system and method for operation for the same

(76) Inventors: Y. Hong Chou, Fountain Valley, CA (US); Tom Farmakis, Sharpsburg, GA (US); Thomas R. Knowles, Peachtree City, GA (US); Al Johnson, Spellville, GA (US)

Correspondence Address: Vic Y. Lin;Myers Dawes Andras & Sherman LLP, 11th Floor, 19900 MacArthur Boulevard, Irvine, CA, 92612, US

(21) Appl. No.: 10/831,462

(22) Filed: Apr. 23, 2004

Related U.S. Application Data
(60) Provisional application No. 60/551,147, filed on Mar. 8, 2004.

(51) Int. Cl. G06F 17/60

(52) U.S. Cl. 705/1; 705/6

(57) ABSTRACT

The system supports special needs customer at an airport. A controller processes request, flight and personnel data, generates assignments, and distributes messages. Workstations register available personnel, import/export customer requests and flight information, edit additional customer and flight data, and authorize or overwrite dispatch decisions. Handheld devices provide customer registration, service recording and location registration, and communicate service instructions and activity planning. The controller receives and analyzes data based upon a set of conditions that determine the status of any service request, the location where service is needed, the type of assistance needed, its priority, and the destination of the service. Upon arrival at the destination, or, based upon a set of predetermined conditions, the controller analyzes current conditions, determines the next set of requests and assignments, and provides information needed to support the next assignments. In an emergency, the controller prioritizes the emergency, and reports the emergency to dispatchers.

### RELATED APPLICATIONS

The present application is related to U.S. Provisional Patent Application Ser. No. 60/551,147, filed on Mar. 8, 2004, which is incorporated herein by reference and to which priority is claimed pursuant to 35 USC § 119.

### BACKGROUND OF THE INVENTION

1. Field of the Invention

The invention generally relates to the field of wireless apparatus that provides information in the support of providing customer service. More particularly, the present invention relates to an apparatus and method for analyzing specific customer information and flight or travel information in order to provide more efficient customer services and reporting of pertinent information.

2. Description of the Prior Art

AIR 21

In April, 2000, the 106^{th} United States Congress passed Congressional Bill HR1000, enacted as the Wendell H. Ford Aviation Investment and Reform Act for the 21st Century, or simply, AIR 21, which increased civil penalties for disabilities violations, with a maximum fine of $10,000 per complaint to be levied against airlines for each violation. Since AIR 21 was enacted, the Department of Transportation (DOT) has fined several airlines, in one case the fine was in the amount of $3.2 M. The amount of the fine was mitigated to $700,000, plus requirements to ensure compliance in the future. The DOT enforcement office increased staffing and intensified efforts to investigate airlines on disabilities and discrimination violations. The present invention is designed to offer a state-of-the-art, cost-effective solution to assist airlines maximize airport customer support while minimizing any such violation addressed in AIR 21.

The Air Carrier Access Act

Carriers are required to provide services for customers with disabilities as stated in the Air Carrier Access Act (ACAA). Airlines are required to provide the following:
Wheelchair transportation to and from gates
Assistance in enplaning, deplaning, and connections
Adequate seating accommodations
Available ramp/mechanical lift devices on aircraft
Accommodation for medical requirements such as oxygen
Stowage of Personal equipment such as wheelchairs
Accommodation for service animals
Accessible aircraft and lavatories
Designated Complaint Resolution Officer (CRO) in each station worldwide
Prohibited from charging for accommodations
Required to replace damaged wheelchairs and assist devices immediately

The potential liabilities for violations of the above stated requirements include enforcement action by the DOT, as well as, negative media exposure, customer perception, and loss of potential revenue to the airline involved.

Customer Complaints

Customer complaints generally involve two major elements:
Failure to provide wheelchair
Wheelchair wait time

Some airlines have established a Customer Advisory Board, staging Complaint Resolution Officials in all cities, bases, stations, and reservation sales. The airlines have committed a dedicated staff and resources for disabilities programs. Operational areas such as Customer Service, In-Flight Service, and Reservations have formal training programs on disability issues. Additionally, cross-divisional DOT resource groups and disability core teams comprised of representatives from several corporate divisions have been established. Some airlines participate in the Air Transport Association (ATA) and quarterly DOT forums. Some airlines have also established leadership performance objectives corporately and with contractors.

The Prior Technology

Yue-Hong Chou “Method and Apparatus for Continuously Locating and Object”, U.S. Pat. No. 6,327,533 (2001) involves an automated system, using GPS or any other location-detection means, to continually locate a moving object. An object tracking system (1) computes and stores the history file inside a internal processor of the mobile unit, (2) computes and adjusts object location whenever the GPS signal or any terrestrial location-detection signal, is invalid, and (3) dynamically evaluates and adopts the most cost-effective communication protocol among multiple means of wireless communication. In the situation where an airport may have multiple wireless communication networks, and the connectivity is critical for a specific customer support dispatch operation, this system can be used to ensure un-disrupted connection between dispatchers and agents.

In Yue-Hong Chou “Thin-client Real-time Interpretive Object Tracking System”, U.S. Pat. No. 6,363,320 (2002) a fully automated system tracks moving objects in real time, using thin-client receiving devices such as PDA, pager, Mobile data Terminals (MDT), cellular phones, and any other thin-cline devices. Real-time position information is translated into a set of meaningful location information. This capability allows a tracking system to link the position of a moving object to map features such as Point-of-Interest (POI) or street segments, and correct the current location of the object in consideration. For instance, the GPS position on the thin-client in terms of street names, blocks, and landmarks is expressed in real time, rather than what is employed by all the existing handheld GPS devices where the position is expressed in Latitude and Longitude. This feature is especially useful when the positions of agents and customers are expressed in meaningful location terms, such as a specific gate, a given widget point, or a known facility in a concourse, etc. The real-time expression of such location information is displayed on the handheld device, i.e., a thin-client receiver. However, what is missing from the prior art is a dispatch function for airport customer support.

Koshima et al, “Position Display System of Mobile Terminal,” U.S. Pat. No. 6,349,211, (2002) is a system which is designed to locate a mobile unit in a wireless communication environment, such as that of a cellular phone system, using a small zone communication system to derive the approximate position of the target mobile unit according to its relative position to repeaters. What is missing in Koshima is the ability to determine the approximate position of an agent based on the most cost-effective mechanism available at any airport. What is needed is a system capable of locating an agent which does not rely on any computation of the relative position using the small zone communication system.

Smith et al., “Fully Automated Vehicle Dispatching, Monitoring, and Billing” U.S. Pat. No. 6,430,496 (2002) discloses a system designed for dispatching transportation services in response to pre-defined situations detected in a centralized database. Transportation services that are needed can be stored in the database. What is missing in Smith is the ability to incorporate into the system a handheld device with identification mechanism, which uses a wireless communication to send information to the dispatch system. What is missing in Smith is the ability to dispatch customer support at an airport.

Khalessi et al., “Mobile Crew Management System for Distributing Work Order Assignments to Mobile Fields Crew Units”, U.S. Pat. No. 6,633,900 (2003) teaches a system, using both the local area network (LAN) and TCP/IP protocol, to ensure the successful distribution of work orders to crew members with mobile units. However, the mobile crew management system is built on HTML page with HTTP server. The operation is completely different from the dispatch of airport customer support in many aspects. First of all, job assignments are compiled by the dispatcher through work order. This is different from the situation of an airport where tasks are derived dynamically from a database of customer requests and another database of flight information. Second, the flow of information is structured differently in the crew management system where the concerns are different from the situation in airport customer support. The entire flow chart and data elements of an application required for an airport, and the priority in assignment of customer support, are different from the crew management system presented in Khalessi.

Shah et al., “Method and Apparatus for Tracking Vehicle Location and Computer Aided Dispatch,” U.S. Pat. No. 5,636,122 (1997) is directed specifically for vehicle tracking with a typical Computer Aided Dispatch (CAD) operation. The system has been widely implemented in law enforcement agencies where patrol units are tracked in real time, with a CAD system to communicate between dispatchers in a centralized facility and field officers in patrol units. The problems and functions are not related to the situation in airport customer support.

Kocur, “Method and Apparatus for Assigning a Plurality of Work Projects” U.S. Pat. No. 5,913,201 (1999) teaches a linear programming method to handle the assignment of multiple work projects. The method deals with evaluation of the objective functions against multiple constraints, and identify the most feasible, if not optimal, strategy for project assignment. Kocur uses a linear programming method to assign tasks to agents.

Huang “Method and Apparatus for Aggregating and Dispatching Information in Distributed Systems,” U.S. Patent Application 20020147712, (2002) teaches a method to build a web-based information distribution system, rather than a “dispatch” system understood by most in the tracking and dispatching fields. The word “dispatch” in this application is not used in a conventional manner. The word “dispatch” in both the conventional use and that is used in the present invention means the transaction taken at a centralized facility to issue commands or instructions to a specific recipient, from among a group of possible mobile recipients, in order to guide the target recipient for certain actions. To be compatible with the conventional terminology, Huang's method should be more appropriately named “an information distribution system”, not a “dispatch system”. In his patent application, Huang's method is designed for the operation of a web-based portal service for a specific type of business, such as a hotel chain or a company distributing information and collecting reservations for multiple hotels. Huang fails to teach the use of handheld Personal Data Assistant (PDA) or other devices, with an identification means such as barcode scanner, swipe card reader, and the like, and the centralized system controller links the customer requests for special assistance, flight information, and the database of agents and their status, into an automated dispatch operation.

Wood et al., “System for Communicating and Associating Information with a Geographic Location,” U.S. Patent Application 20040006425 (2004) presents a mobile mapping/dispatch system with map display on a Mobile Data Computer (MDT). This approach has been previously widely implemented among public safety and law enforcement agencies. Since 2000, many more agencies have implemented a more advanced mobile mapping/dispatch system. The system links the information associated with the current location of a mobile unit, such as a police patrol or a fire engine, to any other piece of information related to the assignment of the vehicle, such as a crime incident or a fire.

### OBJECT OF THE INVENTION

It is one object of the invention to address technology enhancements that potentially resolve the concerns of Congress, the Public, and the Aviation industry regarding the handling of disabled passengers. The implementation of such technological advancements “raise the bar” to standards that, to this date, have not been achievable.

### BRIEF SUMMARY OF THE INVENTION

The invention is a system for dispatching airport customer support in response to a plurality of service support requests among a plurality of agents subject to the control of at least one dispatcher or supervisor. The system comprises a server to receive the plurality of service support requests and automatically process all data related to the plurality of service support requests and to provide real-time distribution of related data. At least one work station is provided through which the agents and/or dispatcher to sign-on and off the system. Each of the agents carry or are assigned at least one handheld device. A wireless communication network supports the real-time data transmission between the server, work station, and handheld devices. The server automatically correlates spatial and nonspatial information relating to the plurality of service support requests from which correlations dispatch decisions to provide commands to the agents are generated and by which the plurality of service support requests are satisfied in compliance with predetermined guidelines.

Each agent, supervisor, and manager has access to a handheld device. The handheld device, in addition to its processing power, is equipped with (1) a wireless communication tool, such as Wi-Fi (802.11), Bluetooth, a cellular network, a digital data network, or any digital wireless communication means; (2) a screen to display messages and allow the person to enter specific action code; (3) a identification device, such as a barcode scanner, a swipe-card reader, an RF ID, or any other input means for the person to identify locations or information on the tickets, boarding passes, or any other means to identify the customer or a location.

Each agent, supervisor, and manager may sign-on/off the system either using the handheld device or at a workstation. The person signed on will become an active member or node of the system, until the person has signed off the system. Each active member may change the status among available, assigned, temporarily off, etc. using either the handheld device or at the workstation. Any change of any member is automatically registered to the server through the wireless communication network.

The server records the current status of each active member in the system. A screen can be used to display the current status of any active member, using different symbols, colors, or status code, to differentiate the current status. A supervisor or a manager will know the exact status of any active member.

The system uses either a direct database link, an import/export procedure, or manual entry to record all the demands of customer support at all times. Each customer who demands support is registered in real-time with the current status of arrival time, arrival flight, arrival gate, departure time, departure flight, departure gate, and any other information related to the demand for support.

The system responds automatically to any flight change in real time, including the change of arrival time and gate, departure time and gate, and any other related information.

The system automatically matches the customer support requests/needs to the available agents, and offers options as to automatically assign a deal to one or more agents or to let a manager or a supervisor to manually assign a deal to one or more agents. The manager or supervisor may always overwrite what the system suggested.

The system assigns deals to agents according to a pre-defined priority schedule. A “deal” is a task responsive to a specific customer service request. For instance, a customer has been waiting for service longer can be given a higher priority than one has just arrived. The customer that has a shorted time to departure can be given a higher priority than one has a longer time to departure. Other rules of service priority can be established.

The assignment of deals to agents takes into consideration the special requirements of the support, such as wheelchairs, carry-on/off, or any other types of needed services. The system will identify the agents that are qualified to provide the service of a deal, and either automatically show the best qualified agents, or list the best qualified agents for the supervisor/manager to assign the deal.

The assignment of any deal to one or more agents takes into consideration the current location of the active agents, and identifies those agents closest to the deal. The location may include terminal, gate, facility, walkway, as well as any location that can be displayed on a map layout.

A map display can be implemented to always show either the current position of each agent, or the last reported position. The position can be automatically registered when the agent register the location at a gate, a transfer point, or at any facility, using the handheld device to transmit the position information automatically to the server.

The map display can show locations of customers waiting for services, agents and equipment available to provide the needed services. Each can be represented as a dot with a different symbol or color to indicate different status. The map also shows the closest agent to any specific need.

The agent may press a button, or enter a specific code, on the handheld device to register his/her current position. Such action will enable the current position to be registered automatically to the system through the wireless communication means.

The system computes the lapsed time since arrival of any customer, and displays the status including agents assigned, agents to be assigned, agents arrived, service provided, etc.

The system issues warning signals to the supervisor or manager if any customer has been waiting for a set period of time, such as ten minutes or any interval appropriate. This will help the supervisor or the manager to take immediate action and offer the needed services.

The system records all the activity of the services, flight information, and customer requests in the database, and can retrieve any piece of such information for analysis or for verification. The retrieved data can be used as legal document to verify the support services provided.

The system can generate periodical service reports, summary statistics, and exception reports of the services provided. The reports can be used to analyze the efficiency of the operation for improvements.

The system can be expanded into a seamlessly integrated system providing several common airport operations including cabin service, ramp, and cargo services. Each service type requires an additional database, updated in real-time and linked to the flight information database and customer support database. For this purpose, the database of agents will be increased to include other types of personnel supporting the related services.

The system can be adapted to several airline or transportation industry operations for rail, bus, or ground transportation. A location detection device, such as GPS or any terrestrial positioning system, will be implemented at each vehicle. Their locations can be displayed on the same dispatch map display as the airport customer support dispatch system.

It is also to be expressly understood that the invention is a method by which the dispatch of airport customer support in the system described above is performed.

Thus, it can now be appreciated that the present invention is an apparatus and method of analyzing information to provide customer service. Implementation of geographic information systems (GIS) and mapping technologies provide the following benefits:
Enhances the service and safety of passengers and employees
Provides employee location to improve response times for assisting customers
Monitors compliance issues (i.e.—wait times) without the need to physically observe on-site, potentially reducing the exposure to DOT fines
Collects historical data for evaluation of employee movement, wait times, stops, time assistance began and ended, etc.
Collects historical data for the number of customers handled per employee
Enables the dispatcher to resolve situations immediately instead of competing on a congested radio frequency
Reroutes employees during irregular operations by an improved method, keeping response times as efficient as possible.
Allows employees to notify dispatch personnel of specified events through the push of a button (i.e.—emergencies, passenger requests for restroom or food breaks, mechanical breakdowns, etc.)

Specifically, the proposed invention will accomplish the following, and help facilitate the reduction in customer complaints:
Provides automatic flight change information—with agent alert
Alerts the dispatcher for additional assistance and dispatch nearest available agent to gate (thus reducing wait time), if no documented Special Service Request (SSR) exists,
Records the time and alerts the dispatcher when a flight is cleared of passenger inbound/and the passenger is delivered outbound (Inbound: the system will look at flight arrival time and tie the flight number and arrival time to the passenger(s) attached to that flight number; and Outbound: the system will look at the time a passenger was delivered to the outbound flight/gate).
Interfaces the Dispatcher in an automated manner to assign priority of dispatch
Identifies by an employee ID—scanner who handled which passenger
Generates reports for the following scenarios:
   1. 30 minute failures
   2. Average passenger wait times
   3. Average passenger process times (from point of contact to point of delivery)
   4. Deals handled per agent
   5. Deals handled per concourse
   6. Deals handled per passenger transfer point
   7. Unaccompanied Minors (UNMs) handled (a history of chronological events by customer name)

The following information is an outline of how the system works. It is not intended to be a complete list of requirements:

System Requirements

A. Interface with the airlines' reservations system (RES) to provide the following information:
Passenger name
Flight number and date
Special Service Requests (SSRs)—the system will need to identify when a SSR does not exist and document that event
Seat location
PASSENGER contact—phone number and/or email address

B. Interface with the airlines' operations system to provide the following information:
Flight number arrival gate/time
Next destination flight number departure gate/time (may have multiple flight segments—only need the next segment from the local station unless system-wide or global dispatching is required)

The airlines' Reservations and Operations systems (database) will deposit the identified data into a central location (e.g.—server) in a specific format (e.g.—ASCII) that the application will then utilize for the dispatch operation. The airlines' system will need to provide updates, say every 3 minutes that the Dispatch software will poll for changes (e.g. Gate changes). Should a change occur, the system would provide an automatic alert to the employee agent in the field.

C. Adjustable Standards:
The employee agent will not be allowed to scan more than a specified number of customers being handled, but number of customers handled will be adjustable within the system
The number of customers allowed Electric cart—limit PASSENGER deals to 5, but this will be adjustable in the system
Supervisor/Lead—there is no limit on the number of requests which a supervisor or lead man can undertake
Transfer point—there is no limit on the number of request involving transfer points that can be undertaken
Bus/Van—there is no limit on the number of requests involving buses or vans that can be undertaken

D. The system will provide for adjustable/set time standards:
15 minute alert for deals not handled (based on OSS flight arrival gate/time)
30 minute alert (based on OSS flight arrival gate/time)

E. Other requirements (according to user option):
Auto call to parent of Unaccompanied Minor (UNMN) when handled (meaning at the departure gate or any predefined area or event—the customer will indicate whether they want notification)
Auto call to designated person (taken from the phone information provided) of the SSR passenger when handled (meaning delivered to the departure gate or any predefined area or event—the customer will indicate whether they want notification)

The service in the two features listed above would likely be handled by the Reservations agent when the passenger calls for a reservation and the SSR is generated. This may necessitate another new “entry” to be made by Reservations that is not listed above. The system design would need to be able to identify this data.

An Example of Operational Process Flow
The APA will scan the customer's boarding card at point of contact or select the customer's name from a list
A bar code will be placed at pre-defined locations (e.g.—curbside, transfer point, gate, van, passenger holding area for unaccompanied minors or other people, etc.)
Each time the customer is handed-off to another APA agent, the receiving agent will scan the boarding card
Each time the passenger transits a pre-defined point, the agent will scan the bar code at the designated area
Once the passenger has arrived at the drop-off point (e.g.—departure gate, baggage claim) the agent will scan the location, then push a button, alerting dispatch that the task is complete, and the agent is available for the next assignment
The system will determine where the nearest assistance is required and send a message to the agent advising where to proceed. Dispatch priority, among other things, is based upon flight arrival time, gate location, and priority of handling such as wait time standards or type of assistance needed.

The above description gives an example of the operational procedures that may be modified to fit the specific consideration at an airport or for a specific carrier.

The present invention involves an apparatus and method for providing an automated dispatch system of customer support for people requiring special assistance at an airport. The system consists of (1) a system controller that processes all the data associated with the requests, flights, and personnel, generates recommendations or decisions on assignments, and distributes messages to the appropriate persons; (2) one or more dispatch workstations designed for registration of available personnel, import/export of customer requests and flight information, entry and edit of additional customer and flight related data, and authorize or overwrite any dispatch decisions recommended by the system controller; (3) one or more handheld devices providing such functions as customer registration, service recording, location registration, receiving and sending of any service related instructions or records, and activity planning. The handheld device has a mobile processor and terminal such as a Personal Data Assistant (PDA), one or more digital wireless communication means, and an identification/registration input device such as barcode scanner, swipe-card reader, or other. The system controller receives and analyzes data based upon a set of conditions that, among other things, determine the status of any service request, the location where the service is needed, the type of assistance needed for each request, the priority of each request, and the destination of the service. Upon arrival at the destination, or, based upon a set of pre-determined conditions, the system controller analyzes current conditions, determines the next set of requests and assignments, and provides information needed to support the next assignments. In the event of an emergency, the system controller will prioritize the emergency and report the emergency and the approximate location of the emergency to the designated dispatchers. This entire dispatch system can be fully automated while offering features to allow for human interactions if needed. This invention can be adapted to several airline or transportation industry operations such as cabin service, ramp, cargo, rail, bus, or ground transportation.

The technologies used in the invention, GIS (Geographic Information Systems), Digital Mapping, Scanning, and Wireless Communications, are already proven. The combination of these technologies in the invention improves customer/employee safety and service, and enhance efficiencies in dynamic dispatching and management of personnel and customer service.

Passengers with special needs are handled everyday on a large scale at major airports worldwide. The efficiency of handling several thousand special assist passengers on a daily and weekly basis is dependent on several factors operating in synchronous effort. Dispatchers utilize passenger flight information to determine where manpower and resources should be best allocated. Presently utilized manual technologies and procedures are not capable of addressing a resolution to ongoing customer complaints such as wait times and human error. The technology enhancements in this invention clearly improve not only the efficiency of an operation, but also provide analytical tools that affect the entire perspective on how an operation could be managed.

For example, the service and safety of passengers and employees are improved. The proposed invention provides employee location to improve response times for assisting customers. The monitoring of DOT compliance issues (i.e.—wait times) without the need to physically observe on-site is possible, potentially reducing the exposure to DOT fines.

Part of the problem with addressing an overall solution has been that no hard, valid, verifiable information has been available to determine how and where service failures occur. The invention collects historical data for evaluation of employee movement, wait times, stops, time assistance began and ended, etc. Historical data for the number of customers handled per employee is collected. A dynamic, GIS-based dispatch system allows the dispatcher to resolve situations immediately instead of competing on a congested radio frequency. Improved methods reroute employees during irregular operations, keeping response times as efficient as possible. The employee is able to notify dispatch personnel through the push of a button (i.e.—medical emergencies, passenger requests for restroom or food breaks, mechanical breakdowns, etc.). Report generators provide management opportunities to determine the root cause of problems and correct systemic deficiencies.

Implementing these technologies creates a higher industry standard. The invention is an apparatus and method of analyzing information in the support of providing customer service.

While the apparatus and method has or will be described for the sake of grammatical fluidity with functional explanations, it is to be expressly understood that the claims, unless expressly formulated under 35 USC 112, are not to be construed as necessarily limited in any way by the construction of “means” or “steps” limitations, but are to be accorded the full scope of the meaning and equivalents of the definition provided by the claims under the judicial doctrine of equivalents, and in the case where the claims are expressly formulated under 35 USC 112 are to be accorded full statutory equivalents under 35 USC 112. The invention can be better visualized by turning now to the following drawings wherein like elements are referenced by like numerals.

### BRIEF DESCRIPTION OF THE DRAWINGS

FIG. 1 is a simplified block diagram of the software modules as situated in various hardware locations comprising the system of the invention.

FIG. 2 is a diagrammatic depiction of the execution program in the dispatch center.

FIG. 3a is a depiction of the first user interface screen for a customer service request on a handheld device.

FIG. 3b is a depiction of the second user interface screen for a passenger customer service request on a handheld device.

FIG. 3c is a depiction of the user interface screen on a handheld device for a service request other than that of a customer service request.

The invention and its various embodiments can now be better understood by turning to the following detailed description of the preferred embodiments which are presented as illustrated examples of the invention defined in the claims. It is expressly understood that the invention as defined by the claims may be broader than the illustrated embodiments described below.

### DETAILED DESCRIPTION OF THE PREFERRED EMBODIMENTS

In the illustrated embodiment, the terminology is intended to be understood in general or broad terms, and can be modified as necessary to address not only the handling of passengers, but to provide dispatch service to other areas of an airline operation, including cabin service, ramp, cargo operations, etc. Most of the fields are called differently for different airline carriers or at different airports. The data type may also vary from system to system. The description is intended to teach how to construct the system 10 in general. In many aspects, the definition of data elements, the flow of data, and the operation of the system 10 can be modified while still keeping the original design concept.

Dispatch System Conceptual Framework

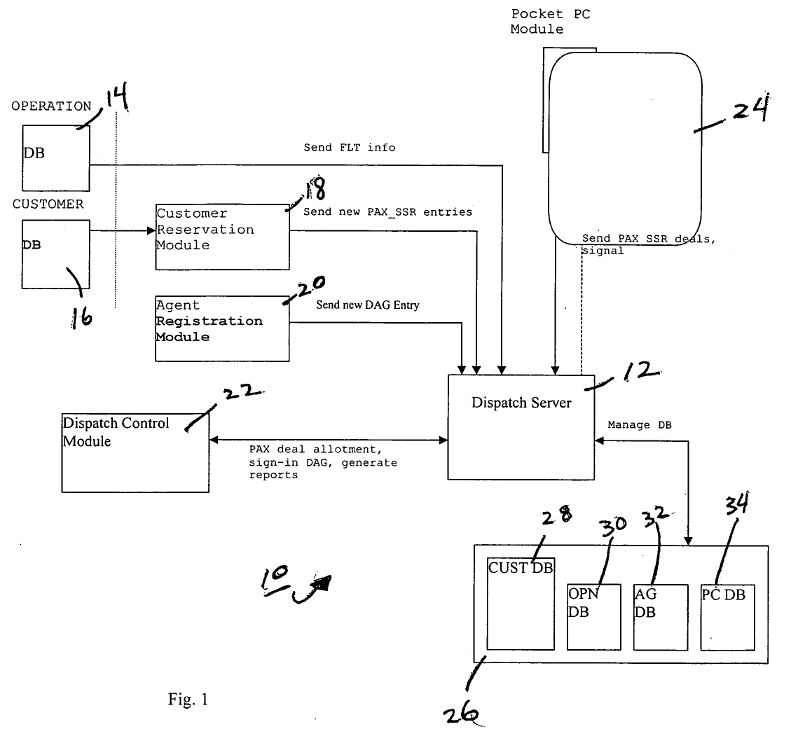

The conceptual diagram of FIG. 1 shows the major software/hardware modules in the dispatch system 10, their interconnection, and the data flow between the modules. In the illustrated embodiment operation is centered around a server 12. Operations database 14 is communicated to server 12 and provides flight information. The customer database 16 communicates to a customer reservation module 18, which is communicated to server 12, and provides passenger information/special service requests (PAX-SSR) to server 12. Similarly, an agent reservation module 20 is communicated to server 12, and provides dispatch agent (DAG) entries to server 12. Dispatch control module 22 communicates to server 12 and provides PAX deal allotments, sign-DAG, and generates reports as described below. A plurality of pocket personal computer modules 24 are communicated to server 12 for providing PAX-SSR deals. Server 12 in turn is communicated to a management database module 26, which manages information flow into and out of the customer database 28, operations database 30, agent database 32 and personal computer database 34.

Dispatch Execution Program

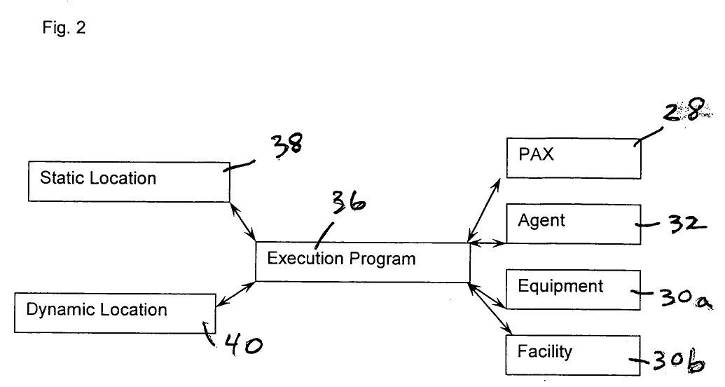

The Execution Program (EP) as diagrammatically depicted in FIG. 2 included as part of server 12 is the central software element of the system 10. EP is a central processor which automatically handles or processes sets of both non-spatial data or information and spatial data or information, and then matches all the service requests with agents, equipment, and facilities based on both a non-spatial data search and stored spatial configuration data. EP 36 is comprised of a direct link to each of the related databases, for example PAX database 28, operations database 30, which includes an equipment database 30a and a facilities database 30b, agent database 32, a static location database 38 and a dynamic location database 40, a series of logical checks, and dynamic distance computations.

EP 36 processes non-spatial data elements including passenger information, service requests, agent availability, agent qualification, equipment availability, equipment classification, facility availability, and facility types. EP 36 retrieves all the data elements in the non-spatial set that are related to each service request, and then passes the selected set of data elements to a central processing unit for matching with the spatial data. Spatial data elements include both the static location data set 38, including such information as gate location, terminal or concourse, widget points, etc. and the dynamic location data set 40 including the most recent position of each agent, the current location of any passenger, and the change of gate for any flight, and others.

In a typical operation, EP 36 receives all the information about a specific request for service, and checks against flight information and possible gate change, identifies the availability and the position of any needed equipment, and identifies any specific facility that needs to be considered. It also computes the distance between any available agent and the gate where the service is needed, and determines the most available, qualified, and closest agents to provide the requested service.

Enumerated Data Types

The enumerated data type lists data specific to the dispatch system 10. Each type supports a set of pre-defined values, and in some cases, the set of values which are supported can be extended to include other relevant data.

| | |
|---|---|
| *SSR_TYPE | Supervisor (S) |
| | Passenger Assist Agent (PAA) |
| | Special Assist Agent (SAA) |
| | Special Assist Agent (SAA) |
| | Electric Cart Agent (ECA) |
| | Transfer Agent (TA) |
| *SSR_EXTENT | International |
| | Domestic |
| *SSR_CODE | Unaccompanied Minor (UNMN) |
| (not a complete listing) | Unaccompanied Minor to be brought by |
| | (TBBB) |
| | Unaccompanied Minor to be met by |
| | (TBMB) |
| | Meet and Assist (MAAS) |
| | Wheelchair passenger (PSGR) - |
| | completely immobile (WCHC) |
| | Wheelchair PSGR cannot use steps or |
| | walk distances, can get to seat (WCHS) |
| | Wheelchair PSGR can use steps and |
| | can get to seat, but cannot walk long distances |
| | (WCHR) |
| | Dry cell battery, must claim at transfer |
| | point (WCBD) |
| | Wet cell battery, must claim at transfer |
| | point (WCBW) |
| | Manual powered wheelchair (WCMP) |
| | On-board wheelchair (WCOB) |
| | Blind PSGR (BLND) |
| | Deaf PSGR (DEAF) |
| | Require Electric cart (EC) |
| FLT_TYPE | Inbound |
| | Outbound |
| PC_STATUS | On - indicates PC is alive |
| | Off - indicates PC is |
| | switched off |
| AGENT_STATUS | Available (AL) - indicates agents is |
| | available for dispatch |
| | Locked (LD) - indicates a service is |
| | assigned to agent, and dispatch is waiting for |
| | acceptance |
| | Assigned (AG) - indicates agent is |
| | servicing a PAX |
| *P_LOCN/D_LOCN | All gates, transfer points, etc., |
| | where barcode/location is provided |
| *GATE_TYPE | Transfer point |
| | Terminal |
| | Other types where barcode/location will |
| | be provided |

*The dispatcher 22 can extend the enumerated list as and when required, where noted by an asterisk above.

Database Schema

The database schema for all the tables supported by the dispatch system 10 is provided below. The attributes names and data types have been listed. The database field name will be modified or tailored to an operation based on specific system requirements. A corresponding list of the field names and attribute names can be provided.

Dispatch agent (DAG) table stored in the agent database 32 holds agent information. The dispatcher or (authorized personnel) will add entries to this table through module 20 and make available a list of agents to the system 10. Dispatch agent (DAG) table includes the information and data in Table 1.

TABLE 1
Dispatch Agent (DAG) Table

| Attribute Name | Data type |
|---|---|
| Employee_ID | Text |
| First_name | Text |
| Last_name | Text |
| Airline | Text |
| SSR_type | SSR_TYPE |
| SSR_bounds | SSR_EXTENT |
| Reg_date | DATE (registration |
| | date) |
| Status | Text |
| Concourse | Text |
| Work area | Text |
| SpCode | Text (indicating seal |
| | color for INTL agents) |

The flight information (FLT_INFO) table stored in the operations database 30 holds flight details, such as, flight number, gate assignment, arrival/departure time, etc. These table entries must be input periodically to update the system 10 with the current flights and gate changes. The flight information (FLT_INFO) table includes the data and information shown in Table 2.

TABLE 2
Flight Information (FLT_INFO) Table

| Attribute Name | Data type |
|---|---|
| Airline | Text |
| FLT_in | Text |
| Eqpt_in | Text |
| Eqpt_out | Text |
| Orig | Text |
| Dest | Text |
| ArrTm_ETA | TIME |
| DepTm_ETA | TIME |
| Flt_out | Text |
| Freq | Text |
| GndTm | TIME |
| PowerTurn (late flights or | BOOL (yes/no) |
| aircraft with minimal ground time) | |
| Gate_No | Text |
| Gate_No_Change | Text (record most recent |
| | gate change) |
| ArrTm_ATA | TIME |
| DepTm_ATA | TIME |

The PAX_SSR table stored in the customer database 28 will hold all the information about passengers with special request services. The passenger entry module 16 will provide the form to fill in the contents of this database. The module can be made available on ______ DGS reservation system. The PAX_SSR table is includes the data and information shown in Table 3.

TABLE 3
PAX_SSR Table

| Attribute Name | Data type |
|---|---|
| Record_locator | Number |
| First_name | Text |
| Last_name | Text |
| Flight_No | Text |
| Date | DATE |
| Seat_No | Text |
| Orig | Text |
| Dest | Text |
| SSR_CODE | SSR_CODE |
| Connect_FLT_No | Text |
| Connect_Date | DATE |
| Connect_Seat_no | Text |
| Orig | Text |
| Dest | Text |
| Pick_up_locn | P_LOCN |
| Pick_up_time | TIME (time when agent scans PAX/gate |
| | barcode) |
| Drop_of_locn | D_LOCN |
| Drop_of_time | TIME (time when agent scans PAX/gate |
| | barcode) |
| Agent_ID | Number |
| Auto_call | BOOL (whether an automatic notification |
| | is to be made for PAX after dispatch) |

The agent activity table stored in agent database 32 is for monitoring everyday activity of an agent. This table will list the agents available for service through the day. It will also reflect the service status of agent. The agent activity table includes the data and information shown in Table 4.

TABLE 4
Agent Activity Table

| Attribute Name | Data type |
|---|---|
| Agent_ID | Number |
| Login_time | TIME |
| Logout_time | TIME |
| Current_locn | Text |
| Supervisor_ID | Number |
| Date | DATE |
| PC_ID | Number |
| Recent_login_time | TIME |
| Service_status | SERVICE_STATUS |
| Number_of_deals_{—} | Number |
| served | |

The pocket personal computer information table stored in personal computer database 34 will store pocket personal computer information. For personal computer we only need to know what barcode is associated with a personal computer and the status of the personal computer. The data and information included in the pocket personal computer information table is shown in Table 5.

TABLE 5
Pocket Pc Information Table

| Attribute Name | Data type |
|---|---|
| PC_ID | Number |
| Status | PC_STATUS |

Additional tables stored in server 12 include auto-call Information table (for telephone, personal computer, or pager, etc.) as shown in Table 6, which includes information which provides any contact information for persons which need to be automatically notified upon the arrival or departure of a passenger.

TABLE 6
AUTO-CALL INFO TABLE

| Attribute Name | Data type |
|---|---|
| Contact_first_name | Text |
| Contact_last_name | Text |
| Auto_Call_no | Number |
| Email | Text |
| Call_time/email_{—} | TIME |
| send time | |

A gate barcode information table as shown in Table 7, stored in server 12 includes information which correlates a location or other text data with a numeric bar code.

TABLE 7
Gate Barcode Info Table

| Attribute Name | Data type |
|---|---|
| Gate_ID | Number |
| Gate_name | Text |
| Gate_desc | Text |
| Concourse | Text |
| Gate_type | GATE_TYPE |

Agent type and corresponding code information table stored in server 12 as shown in Table 8, which includes information which pertains to the qualification of the agents for the various classes of services which may be rendered.

TABLE 8
Agent Type And Corresponding Code Information Table

| Attribute Name | Data type |
|---|---|
| SSR_type | SSR_TYPE |
| SSR_code | SSR_Code |

General Data Flow

Described below is the logical sequence of data flow for the core functions in the system 10.

Logical Flow for Entering (or Receiving if Automated) PAX Information

Step 1: Enter PAX_SSR details: first_name, last_name, fit_no, date, seat_no, SSR_CODE

Step 2: The system 10 will determine if flight is inbound or outbound based on flight number and date
A. if (PAX flight==Inbound flight)
1. if there are any connections to be made,
   a. enter connect_flt_no, connect_date and connect_seat_no. The system 10 will automatically enter the pick up locn and the drop_off_locn, as the arrival gate of flight and departure gate of connect_flt, respectively
2. Else (if no connection)
   a. enter drop_off_locn. The system 10 will obtain the pick_up_locn automatically from flt information database
B. if (PAX flight==outbound flight)
   1. enter pick_up locn. The system 10 will automatically fill the drop_off_locn as the fit gate no.
C. If auto-call capability is required
   1. enter detail for auto-call table, such as call-no/email, name of contact person

Data Flow for Signing Up an Agent
Step 1: An agent will go to dispatch center 22 where the dispatcher or supervisor(s) is located, which may be a physical check in counter where each of the agents initially report for work or it may be a virtual check in location on the network. Supervisor will scan in agent barcode and personal computer barcode. These values get entered into the agent activity table. The system 10 takes in the current time as login_time and current date as date. The supervisor also needs to scan his barcode in to show authorization.
Step 2: The Dispatch program on the pocket personal computer 24 will be started, the personal computer will ask to confirm the agent information. The agent then takes the pocket personal computer 24.
   a. agent status is marked available
   b. the agent needs to scan the gate barcode to indicate his location. By default the system 10 will have the dispatch center (where the agent sign's in) as the location
Step 3: At any time, if the pocket personal computer 24 turns off, when restarted, the agent needs to confirm that his information displayed is correct to proceed. The recent login time is updated.
a. If the information in the personal computer does not match the agent id, the agent report back to the supervisor
Step 4: The system 10 will also keep checking to see if the pocket personal computer 24 is on or off. When the pocket personal computer 24 is switched ‘off’, the agent record will be highlighted at the dispatcher screen to indicate that the pocket personal computer 24 is turned off. A system alert will be given to the dispatcher, if the personal computer 24 is off for time t or more.

Priority of Agents Available for a PAX SSR Request
1. Agent must meet SSR_type and extent, such as international, domestic, power turn, etc.
2. Agents must be nearest to PAX

Dispatch Priority
1. PAX elapsed time since arrival is >t
2. PAX whose connection/departure time is <t
3. Carry off request
4. Carry on request
5. Non-SSR requests in the order of the SSR requests above.

A non-SSR request is a request that originates from other than a prearrival passenger communication made as part of the initial booking process. A non-SSR is typically a special on-site request from a ticket agent or gate agent. Non-SSR requests that may be higher than some SSR requests will be served ahead of the SSR requests.

Logical Sequence to ASSIGN PAX Deals to Agent
Step 1: All flights in the FLT database are ordered by time. Get all flights that are due to arrive in time t. The dispatcher can set t to half hour, 1 hour, or 10 min, as required.
Step 2: For each flight in the list
   A. The system 10 will get the PAX list from PAX_SSR table and the list of agents available for the day. Order PAX_SSR list by SSR type
   B. For each SSR type
      a. The system 10 will find PAX count with similar SSR needs, from that identify PAX with similar dispatch gate nos. Based on this, system 10 identifies how many agents (n) need to assigned to that gate. By default the system 10 will initially allot at least one agent to each gate.
      b. Locate n nearest agents, and display the deal with the PAX information and agent information to the dispatcher
      c. The dispatcher needs to confirm the deal. The dispatcher can also choose to verify a batch of deals together instead of confirming each deal individually. The number of deals in a batch can be provided as a variable.
      If deal is confirmed
         i. All deal information is sent to the selected agent (s). (Information about gate_info, fit_no, SSR_type, number of PAX will appear on agent personal computer)
      a. Else
         i. The dispatcher can choose a particular agent and confirm the deal. The system 10 will alert, only if a deal will lead to an over allotment to an agent. For e.g. if it is defined that an electric cart can carry 5 PAX, and if the deal is assigning 6 PAX, the system 10 will alert to assign one more agent.
         ii. Go back to step d.
Step 3: The agent pocket personal computer 24 will beep/vibrates to alert the agent that a deal has arrived.

Sequence to Check Deal Acceptance

The pocket personal computer dispatch program will give information about the required service such as gate_no, flight_no, time, number_of passengers. PAX information will also be provided, in a condensed way. The agent can click and view all details about passengers as required.

Step1: Once a deal is dispatched to an agent, the agent service_status is marked ‘locked’.

Step2: Agent screen prompts service information such as, gate_no, flight_no, time, number_of passengers. The agent can also check PAX information, drop_off_locn etc.
Step3: Agent will click on the accept button. The agent can accept only once and the button will be disabled thereafter.
Step4: When ‘accept’ information reaches the server, the system 10 will mark the agent as ‘Assigned’
Step5: The deal will now appear in the ‘Service Status window’, where the dispatcher can monitor the deal completion

Sequence of Operations While Executing a Deal
Step1: the agent will go to the gate where he is to serve, and scan the gate barcode. The agent location and time is sent to server
Step2: when a PAX_SSR comes out of the gate, the agent can approach the PAX and scan the PAX ticket to get the PAX record.
Step3: if PAX ticket is unavailable, the agent can go to tab2 (screen) check name of PAX and select PAX record for service.
Step4: once the system 10 identifies the PAX either by ticket scan or by manual selection using name, it will display the ‘Assigned’ information to the server.
Step5: if the agent is assigned more than one deal, as in the case of electric cart, he should repeat steps 2 through 4, until he has met all the SSR PAX. The agent can check number of remaining PAX at this terminal by looking at the PAX_count in the summary page, to be served at this gate.

Step6: The agent now takes the PAX to his destination as displayed in the personal computer 24. When the agent reaches the destination, he will scan the gate barcode to indicate completion of task and his current location.

Step7: The agent will push a button to confirm completion of service.

If the agent has to stop somewhere for the PAX while in service, provision will be made to record the event by the agent.

Sequence to check deal completion
Step1: The dispatcher will monitor the ‘Service Status window’. The assigned deals will appear in order of time, with all information, about agent, PAX, gates, etc.
Step2: Once a service is completed, the agent must send his location by scanning the gate barcode.

Step3: If the agent location matches the PAX dispatch location and the complete button is pushed, the deal is identified as completed

Handle Flight Gate Change after Assigning to an Agent
Step1: Find, if any, available agent nearest to PAX
If agent available,
   a. send deal information, wait for acceptance
   b. if accepted, pull previously assigned agent record to whom the deal was assigned. Send deal cancel message and ask to confirm. Wait for accept message from agent. Else
   c. Send message with updated gate change information and ask to confirm

System Alerts Will be Given in Following Cases
1. For inbound flights if a deal is not assigned t min before the flight arrival time
2. If a pax wait time has elapsed t min
3. If agent location does not match pick-up/drop_off_locn location before flight arrival and departure time, respectively.
4. When a flight is cleared of all the SSR and Non-SSR requests
5. When an agent pocket personal computer 24 is switched off for more than time t.
6. If an agent has arrived at the gate and a PAX fails to report to agent, alert signal is sent to dispatcher
7. Dispatcher can send signal to agent if he doesn't report after lunch break

Handle a Non-SSR Request
Step1: Agent will scan PAX ticket or check for name
Step2: If no match found
   A. If agent is already assigned and cannot serve PAX
      i. Send Non-SSR request with PAX SSR_code to server, dispatch
   B. Else if agent can accommodate PAX
i. Enter Non-SSR request information (PAX name, ticket information, etc.)
ii. Send msg to server with Non-SSR PAX details
iii. Confirm service with dispatcher, proceed to service request

The system 10 will update documentation in passenger records where SSRs did not exist in the airline's reservation system and deliver or place the updated SSR information into the airline's reservation system.

Function List for Each Module

The various modules in the dispatch system 10 each support a group of functions. Listed below is a general description of the functions in each module.
1. PAX_SSR entry module (included in dispatch control 22)
   a. Use PAX_SSR schema information
   b. Create new PAX_SSR information
   c. Edit existing PAX_SSR information

The PAX_SSR data will be added to the PAX_SSR database 28 in the server 12.
2. DAG entry module 20
   a. Use DAG schema
   b. Create new agent information
   c. Edit agent information
3. FLT_INFO entry module 14
   a. Use FLT_INFO schema
   b. Create new flight record
   c. Edit flight record, update gate changes, change in arrival/departure time, and date
4. Agent Log in module 20
   a. Use DAG activity schema
   b. Scan in agent ID, personal computer id, and supervisor id
   c. Allow for manual entry if required
5. personal computer inventory module 34
   a. Use PC_INFO schema
   b. Create/Edit PC record
6. Dispatcher control module 22
   a. View all PAX_SSR that need to be served
   b. View current list of flights in order of time
   c. View agents list and their current status
   d. Confirm and assign deals to agents
   e. Monitor deals for acceptance, and confirmation
   f. Handle alerts
   g. Access to all tables and their records
   h. Print reports
   i. Send alerts to agent pocket personal computer 24
   j. Other functions as required . . .
7. Agent Pocket personal computer module 24
   a. Accept a deal
   b. View PAX_SSR details in the assigned deal
   c. Indicate position by scanning terminal barcode
   d. Get PAX_SSR data by scanning PAX ticket
   e. Locate PAX_SSR information by name, if ticket is unavailable
   f. Record a PAX break while in duty
   g. Record agent break for lunch
8. Map Layout of terminals (included with dispatch control module 22)
   a. Display dots representing PAX at each gate, when PAX is served the dot will disappear.
   b. Display other symbol (triangle) for agents, color of triangle will indicate the agent status
   c. Click on a symbol to see PAX or agent information

Sample General User Interfaces (GUIs) on Handheld Devices

This sample user interface for each module is described below. The main intent is to identify what information needs to be available to and from the user. The screen capture shows the input entries that will be available to the user, and the button for the functions supported by the module.

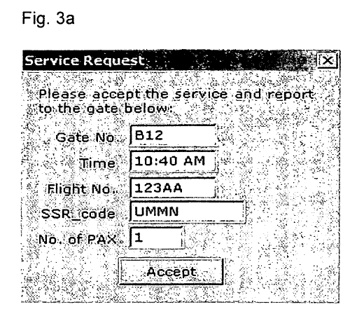

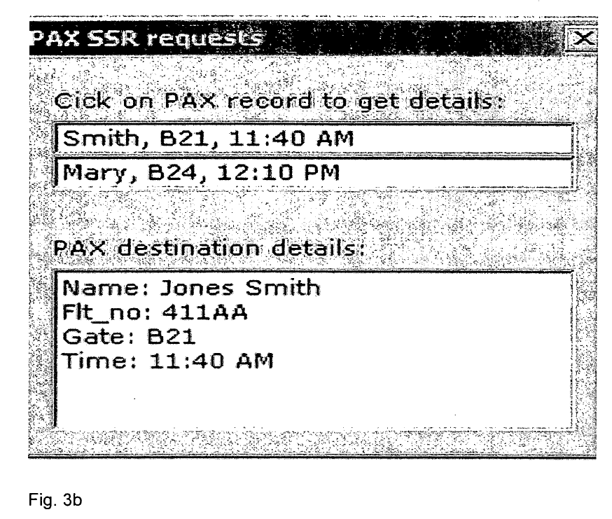

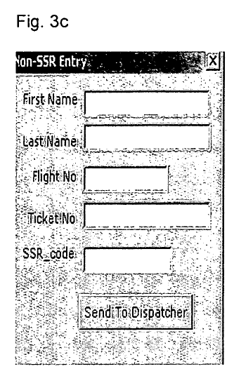

FIG. 3a shows screen 1 of SSR request from dispatcher of the agent pocket personal computer 24. FIG. 3b shows screen 2 of the agent pocket personal computer 24 which shows the PAX_SSR request details. In this example, the agent has to serve only one passenger, as shown in (No. of PAX) screen 1. The agent's pocket personal computer 24 will display list all the PAX arriving from that gate (in case of out-bound flights), and whichever PAX comes first to the agent will be served. So in this example, Smith and Mary are two PAX with SSR, having different connection gates and the PAX who comes first will be attended by the agent. FIG. 3c shows screen 3 for a non_SSR entry.

The module 20 which provides a Registration Center which has the following screens.

Screen 1: Enter Agent information

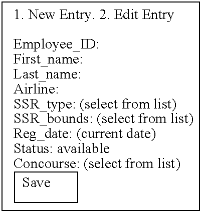

Screen 2: Enter flight information

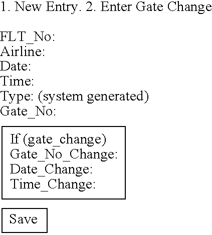

Screen 3: Enter PAX_SSR information

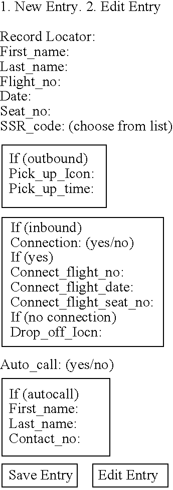

Dispatch Center

The dispatch center 22 has a first screen, the agent log in screen, is as follows.

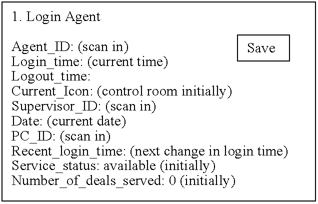

A second screen is directed to the dispatch operation which has two windows as shown below, one to display the different database records and deal activity and the second window to display the corresponding map layout. Window 1 displays all the records in respective grids, in order of priority. The dispatcher can select a record and perform operations. Window 2 displays the terminal layout. The dispatcher can click on the point in the map and get its information in the data box below.

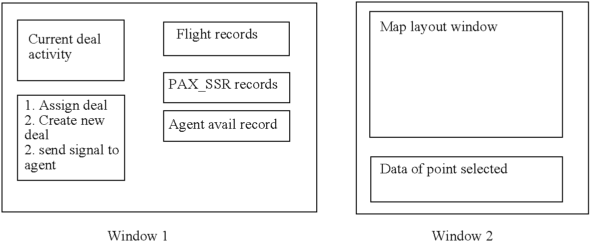

A report is generated on a third screen in the dispatch center 22 which appears as follows.

Screen 3: Report generation

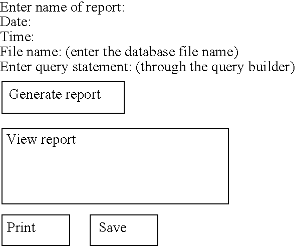

Many alterations and modifications may be made by those having ordinary skill in the art without departing from the spirit and scope of the invention. Therefore, it must be understood that the illustrated embodiment has been set forth only for the purposes of example and that it should not be taken as limiting the invention as defined by the following claims. For example, notwithstanding the fact that the elements of a claim are set forth below in a certain combination, it must be expressly understood that the invention includes other combinations of fewer, more or different elements, which are disclosed in above even when not initially claimed in such combinations.

The words used in this specification to describe the invention and its various embodiments are to be understood not only in the sense of their commonly defined meanings, but to include by special definition in this specification structure, material or acts beyond the scope of the commonly defined meanings. Thus if an element can be understood in the context of this specification as including more than one meaning, then its use in a claim must be understood as being generic to all possible meanings supported by the specification and by the word itself.

The definitions of the words or elements of the following claims are, therefore, defined in this specification to include not only the combination of elements which are literally set forth, but all equivalent structure, material or acts for performing substantially the same function in substantially the same way to obtain substantially the same result. In this sense it is therefore contemplated that an equivalent substitution of two or more elements may be made for any one of the elements in the claims below or that a single element may be substituted for two or more elements in a claim. Although elements may be described above as acting in certain combinations and even initially claimed as such, it is to be expressly understood that one or more elements from a claimed combination can in some cases be excised from the combination and that the claimed combination may be directed to a subcombination or variation of a subcombination.

Insubstantial changes from the claimed subject matter as viewed by a person with ordinary skill in the art, now known or later devised, are expressly contemplated as being equivalently within the scope of the claims. Therefore, obvious substitutions now or later known to one with ordinary skill in the art are defined to be within the scope of the defined elements.

The claims are thus to be understood to include what is specifically illustrated and described above, what is conceptionally equivalent, what can be obviously substituted and also what essentially incorporates the essential idea of the invention.

1. A system for dispatching airport customer support in response to a plurality of service support requests among a plurality of agents subject to the control of at least one dispatcher comprising:
a server to receive the plurality of service support requests and automatically process all data related to the plurality of service support requests and to provide real-time distribution of related data;
at least one work station for the agents and/or dispatcher to sign-on and off the system;
at least one handheld device for each of the agents; and
a wireless communication network to support real-time data transmission between the server, work station, and handheld device,
where the server automatically correlates spatial and nonspatial information relating to the plurality of service support requests from which correlations dispatch decisions to provide commands to the agents are generated and by which the plurality of service support requests are satisfied in compliance with predetermined guidelines.

2. The system of claim 1 where the handheld device comprises:
a wireless communication tool;
a screen to display messages and allow the agent to enter a specific action code; and
an identification device to identify information on a ticket, boarding pass, or other object to identify a customer or location.

3. The system of claim 1 where the agent may sign-on/off the system either using the handheld device or the workstation, where the signed-on agent becomes an active communication node of the system until the agent signs off the system, where the agent may change his status by using either the handheld device or the workstation, and where any change of status of the agent is automatically registered to the server through the wireless communication network for dispatcher review.

4. The system of claim 1 where the server records the current status of each active agent in the system, where a screen is provided on the work station or handheld device to display the current status of any active agent as differentiated by different symbols, colors, or status codes so that the status of any active agent is indicated to the dispatcher.

5. The system of claim 1 where the server uses either a direct database link, an import/export procedure, or manual entry to record all the demands for customer support, and where each customer that demands support is registered in real-time in association with the current status of arrival time, arrival flight, arrival gate, departure time, departure flight, departure gate, or other information related to the demand for support.

6. The system of claim 1 where the server employs either a direct database link, or an import/export procedure, or manual entry to record the flight information in real time, including the arrival time and gate, departure time and gate, and other related flight information.

7. The system of claim 1 where the server responds in real time automatically to any flight change, including the change of arrival time and gate, departure time and gate, and other related flight information.

8. The system of claim 1 where the server automatically matches a customer support request to at least one of the available agents, and offers options as to automatically assign a deal to at least one agent or to allow the dispatcher to manually assign a deal to at least one agent, including overwriting an automatic assignment.

9. The system of claim 1 where the server assigns deals to agents according to a predefined priority schedule.

10. The system of claim 1 where the server assigns deals to agents by taking into consideration the special requirements of the customer support request, identifies the agents who are qualified to provide the requested service of a deal, and either automatically shows the qualified agents or lists the qualified agents for the dispatcher to manually assign the deal.

11. The system of claim 1 where the server assigns a deal to at least one agent by taking into consideration the current location of the active agents, and by identifying those agents closest to the deal.

12. The system of claim 1 where the server generates a map display to show either the current position of each agent or the last reported position, wherein the position is automatically registered with the server when the agent registers the location at a gate, a transfer point, or at any facility, using the handheld device to transmit the position information automatically to the server.

13. The system of claim 1 where the server generates a map display to show locations of customers waiting for services, agents and equipment available to provide the needed services as represented by a differentiated symbol to indicate different statuses and where the map shows the closest agent to any specific need.

14. The system of claim 1 where the handheld device has a button or keyboard for entry of a code to register the agent's current position, activation of the button or entry of the code automatically registering the current position of the agent to the server through the wireless communication network.

15. The system of claim 1 where the server computes the lapse time since arrival of any customer, and displays the status including agents assigned, agents to be assigned, agents arrived, and/or service provided.

16. The system of claim 1 where the server issues warning signals to the dispatcher if any customer has been waiting for a predetermined period of time or longer.

17. The system of claim 1 further comprising a flight information database and customer support database, and where the server records all the activity of the services, flight information, and customer requests in a database, and retrieves selected information for analysis or verification.

18. The system of claim 17 where the server generates periodical service reports, summary statistics, and/or exception reports of the services provided.

19. The system of claim 17 further comprising means for providing an integrated system related to common airport operations including cabin service, ramp, and/or cargo services, wherein each service type has an additional database, is updated in real-time and linked to the flight information database and customer support database, and where the agents include personnel supporting related services.

20. The system of claim 17 further comprising means for adapting the system to transportation operations for water and/or ground transportation, which include a location detection device in each vehicle in the role of an agent.

21. A method for dispatching airport customer support among a plurality of agents in response to a plurality of service support requests subject to the control of at least one dispatcher comprising:
receiving the plurality of service support requests;
automatically processing data related to the plurality of service support requests to correlate spatial and nonspatial information relating to the plurality of service support requests;
generating from the correlations dispatch decisions to provide commands to the agents are generated and by which the plurality of service support requests are satisfied in compliance with predetermined guidelines;
providing real-time distribution of related data and commands;
managing the real-time communication of data and commands between the plurality of agents and a dispatcher through a wireless communication network through the use of a server communicated to the wireless communication network; and
communicating data with the plurality of agents through at least one handheld device carried by each of the agents, which the data is communicated in real time concerning airport customer support requests and the location and identity of available agents

22. The method of claim 21 where communicating data with the plurality of agents through at least one handheld device comprises communicating through a wireless communication tool in the handheld device, displaying a message on a screen in the handheld device, entering a specific action code in the handheld device and identifying information on a ticket, boarding pass, or other object to identify a customer or location.

23. The method of claim 21 where communicating data with the plurality of agents comprises signing on or off either using the handheld device or a workstation, where the signed-on agent becomes an active communication node of network until the agent signs off the network, changing the status of the agent by using either the handheld device or the workstation, and automatically registering any change of status of the agent through the wireless communication network for dispatcher review.

24. The method of claim 21 where automatically processing data related to the plurality of service support requests comprises recording the current status of each active agent in the network, and providing a screen on the work station or handheld device to display the current status of any active agent as differentiated by different symbols, colors, or status codes so that the status of any active agent is indicated to the dispatcher.

25. The method of claim 21 where automatically processing data related to the plurality of service support requests comprises using either a direct database link, an import/export procedure, or manual entry to record all the demands for customer support, and registering in real-time each customer who demands support in association with the current status of arrival time, arrival flight, arrival gate, departure time, departure flight, departure gate, or other information related to the demand for support.

26. The method of claim 21 where automatically processing data related to the plurality of service support requests comprises employing either a direct database link, an import/export procedure, or manual entry to record the flight information in real time, including the arrival time and gate, departure time and gate, and other related flight information.

27. The method of claim 21 where automatically processing data related to the plurality of service support requests comprises automatically responding in real time to any flight change, including the change of arrival time and gate, departure time and gate, and other related flight information.

28. The method of claim 21 where automatically processing data related to the plurality of service support requests comprises automatically matching a customer support request to at least one of the available agents, and offering options as to automatically assign a deal to at least one agent or allowing the dispatcher to manually assign a deal to at least one agent, including overwriting an automatic assignment.

29. The method of claim 21 where automatically processing data related to the plurality of service support requests comprises assigning deals to agents according to a predefined priority schedule.

30. The method of claim 21 where automatically processing data related to the plurality of service support requests comprises assigning deals to agents by taking into consideration the special requirements of the customer support request, identifying the agents who are qualified to provide the requested service of a deal, and either automatically showing the qualified agents or listing the qualified agents for the dispatcher to manually assign the deal.

31. The method of claim 21 where automatically processing data related to the plurality of service support requests comprises assigning a deal to at least one agent by taking into consideration the current location of the active agents, and by identifying those agents closest to the deal.

32. The method of claim 21 where automatically processing data related to the plurality of service support requests comprises generating a map display to show either the current position of each agent or the last reported position, and automatically registering the position of agent when the agent registers the location at a gate, a transfer point, or at any facility, using the handheld device to automatically transmit the position information.

33. The method of claim 21 where automatically processing data related to the plurality of service support requests comprises generating a map display to show locations of customers waiting for services, agents and equipment available to provide the needed services as represented by a differentiated symbol to indicate different statuses and showing the closest agent to any specific need.

34. The method of claim 21 where automatically processing data related to the plurality of service support requests comprises automatically registering the agent's current position through the wireless communication network by activating a button or entry of a code on the handheld device.

35. The method of claim 21 where automatically processing data related to the plurality of service support requests comprises computing the lapsed time since arrival of any customer, and displaying the status including agents assigned, agents to be assigned, agents arrived, and/or service provided.

36. The method of claim 21 where automatically processing data related to the plurality of service support requests comprises issuing warning signals to the dispatcher if any customer has been waiting for a predetermined period of time or longer.

37. The method of claim 21 where automatically processing data related to the plurality of service support requests comprises providing a flight information database and customer support database, recording all the activity of the services, flight information, and customer requests in a database, and retrieving selected information for analysis or verification.

38. The method of claim 37 where automatically processing data related to the plurality of service support requests comprises generating periodical service reports, summary statistics, and/or exception reports of the services provided.

39. The method of claim 37 further comprising providing an integrated method related to common airport operations including cabin service, ramp, and/or cargo services, wherein each service type has an additional database, is updated in real-time and linked to the flight information database and customer support database, and where the agents include personnel supporting related services.

40. The method of claim 37 further comprising adapting the method to transportation operations for water and/or ground transportation, which include a location detection device in each vehicle in the role of an agent.
